(19) United States
(12) Patent Application Publication
(10) Pub. No.: US 2019/0130137 A1
(43) Pub. Date: May 2, 2019

(54) VERSATILE MAGNETIC PRESENCE DETECTION OF A MOBILE COMPUTING DEVICE BY A TAG

(71) Applicant: Conduent Business Services, LLC, Dallas, TX (US)

(72) Inventor: Pascal Roux, Chabeuil (FR)

(73) Assignee: Conduent Business Services, LLC

(21) Appl. No.: 15/797,039

(22) Filed: Oct. 30, 2017

(51) Int. Cl. G06K 7/08; G06Q 20/06

(52) U.S. Cl. CPC G06K 7/087; G01B 7/003; G06Q 20/0658; G06Q 20/0655

(57) ABSTRACT

Methods and systems for the magnetic presence detection of a mobile computing device. In an example embodiment, steps or operations can be provided for detecting with a magnetic sensor (e.g., a magnetic proximity detector) a magnetic field associated with one or more components (e.g., an electromagnetic component such as a speaker) of a mobile computing device (e.g., a smartphone, a tablet computing device, a wearable computing device, etc.), monitoring the magnetic field strength of the magnetic field and/or the first and/or second derivatives of a magnetic field vector of the magnetic field, extracting a perturbation in the magnetic field separately from variations in the terrestrial background magnetic field due to motion; and automatically adjusting detection thresholds and/or continuously compensating magnetic sensor offsets of the magnetic sensor to maximize the magnetic presence detection of the mobile computing device and minimize false detections thereof.

### TECHNICAL FIELD

Embodiments are generally related to the field of short-range communications, such as, for example, BLE (Bluetooth Low Energy) and NFC (Near Field Communications). Embodiments also relate to the magnetic detection of mobile computing devices, such as smartphones, tablet computing devices, wearable computing devices, and so on utilizing RF (Radio Frequency) enabled tags. Embodiments additionally relate to mobile ticketing applications utilized in, for example, public transportation systems.

### BACKGROUND

Ticketing is an essential function in public transportation networks. A ticketing function must successfully address several key requirements from both the traveler's and the operator's perspectives. Typical traveler requirements may include ease of use (easy to learn and routine in practice), clear and visible pricing, secure with respect to loss, theft, or forgery, e.g., ticket books, passes, etc., and privacy preserving. Typical operator requirements of a ticketing function may include user acceptance (barriers to usage can quickly lead to a rejection of the transportation system by the public), security (confidentiality of the transaction, authentication, and non-repudiation, fraud resistance (amateur and organized)), and high availability. Additional requirements of the operator to ticketing functions will correspond to deployment costs, both for infrastructure (readers, validation systems, personnel, etc.) and mobility (tickets, cards, etc., in the hands of the traveler).

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide a method and system for improving the magnetic detection of a smartphone and other types of mobile devices.

It is another aspect of the disclosed embodiments for allowing a tag (e.g., an RF tag, Bluetooth enabled tag, etc.) to communicate with and send data to a mobile computing device.

It is another aspect of the disclosed embodiments to provide for an improved method and system for the versatile magnetic presence detection of a mobile computing device by a tag.

The aforementioned aspects and other objectives and advantages can now be achieved as described herein. Methods and systems are disclosed for the magnetic presence detection of a mobile computing device. In an example embodiment, steps or operations can be provided for detecting with a magnetic sensor (e.g., a magnetic proximity detector) a magnetic field associated with one or more components (e.g., electromagnetic components such as, for example, a speaker) of a mobile computing device (e.g., a smartphone, a tablet computing device, a wearable computing device, etc), monitoring the magnetic field strength of the magnetic field and/or the first and/or second derivatives of the magnetic field vector, extracting a perturbation in the magnetic field separately from variations in the terrestrial background magnetic field due to motion; and automatically adjusting detection thresholds and continuously compensating magnetic sensor offsets of the magnetic sensor to maximize the magnetic presence detection of the mobile computing device and minimize false detections. Regarding the magnetic field vector, note that there is only one vector located at the sensor position and the vector has three coordinates and a length (i.e., the field strength).

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the disclosed embodiments.

FIG. 1 illustrates a block diagram depicting a system for the magnetic presence detection of a mobile device, in accordance with an example embodiment;

FIG. 2 illustrates a schematic diagram depicting one example embodiment of the mobile device (e.g., a client device) depicted in FIG. 1 and FIG. 3, in accordance with an example embodiment;

FIG. 3 illustrates a schematic diagram of magnetic field strength demonstrating that when only the Earth's magnetic field is present and a vehicle moves, the field strength is constant, in accordance with an example embodiment;

FIG. 4 illustrates a schematic diagram of magnetic field strength in a first case and a second case, in accordance with an example embodiment;

FIG. 5 illustrates a schematic diagram of magnetic field strength in a third case, in accordance with an example embodiment;

FIG. 6 illustrates a schematic diagram of magnetic field strength in a fourth case, in accordance with an example embodiment;

FIG. 7 illustrates a graphical representation of the derivative of the field vector in a first case, in accordance with an example embodiment;

FIG. 8 illustrates a graphical representation of the derivative of the field vector in a second case, in accordance with an example embodiment;

FIG. 9 illustrates a graph depicting the temporal evolution of the field vector, in accordance with an example embodiment;

FIG. 10 illustrates a graph depicting the temporal evolution of the first derivative of the field vector, in accordance with an example embodiment;

FIG. 11 illustrates a graph depicting the temporal evolution of the second derivative of the field vector, in accordance with an example embodiment;

FIG. 12 illustrates a table depicting the performance of various detection methods based on field strength, and/or first and/or second derivatives, in accordance with an example embodiment;

FIG. 13 illustrates a flow chart of operations depicting logical operational steps of a method for improving the magnetic presence detection of a user device or client device, such as a smartphone, tablet computing device, and so on, in accordance with an example embodiment;

FIG. 14 illustrates a schematic view of a computer system/apparatus, in accordance with an embodiment; and

FIG. 15 illustrates a schematic view of a software system including a module, an operating system, and a user interface, in accordance with an embodiment.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation”.

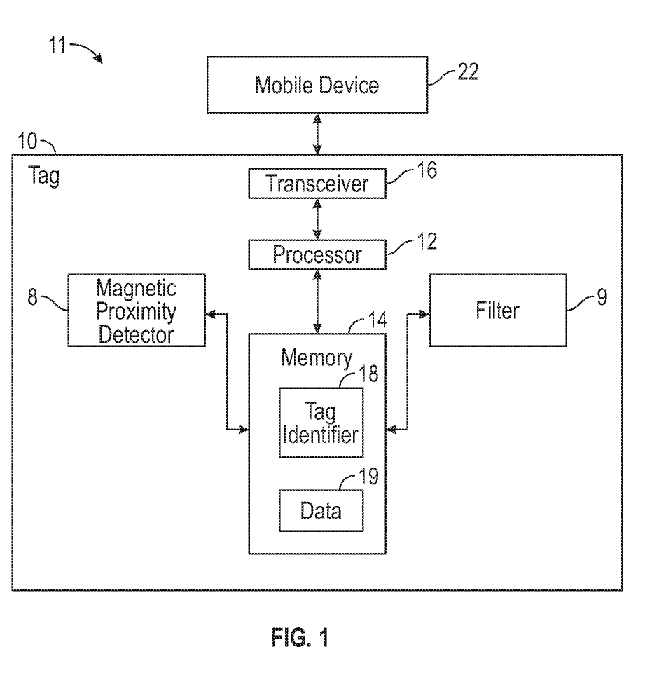

FIG. 1 illustrates a block diagram depicting a system 11 for the magnetic presence detection of a mobile device 22, in accordance with an example embodiment. The system 11 includes a tag 10 that is associated with and/or includes a magnetic proximity detector 8. The tag 10 can be implemented in the context of a wireless system for enabling transactions on an associated network delivering services (e.g., advertisements, data, etc.) to end users in accordance with one aspect of an exemplary embodiment.

Note that the term “tag” as utilized herein can include any kind of device that is non-battery operated (e.g., a non-battery operated device connected to a power supply). In this case, the disclosed detector helps to limit radio spectrum usage and phone battery usage. The term “tag” as utilized herein can also refer to any kind of device that is battery operated, in which case the disclosed detector can additionally limit the tag battery usage.

The tag 10 can transmit particular data 19 when the magnetic proximity detector detects the mobile device 22, which avoids needless battery consumption by the tag 10 and/or the mobile device 22. The tag 10 can further be associated with and/or include a filter 9 that filters out noisy magnetic signals so as to enhance the detection capability of the magnetic proximity detector 8 and additionally facilitate detection of the mobile device 22 by the magnetic proximity detector 8.

One or more tags such as tag 10 can be implemented as a deployed service access point to the associated network, such as entrances, exits, vehicles, stops, barriers, parking lot gates, etc., each tag having a unique identifier, an irreversible counter, a master key, and a log of previous transactions. The tag need not be connected to any network, thus allowing the positioning of the tag on a variety of service access points, e.g., on vehicles of a transportation system, on entrances to venues, on gates to parking lots, etc.

The tag 10 can be powered (e.g., self-contained power supply, not shown). The tag 10 includes a processor 12 in communication with memory 14 and a transceiver 16. The processor 12 may include a random number generator and other suitable components to facilitate the systems and methods discussed hereinafter. The memory 14 may comprise non-volatile and/or volatile memory capable of storing various types of data. The tag 10 may utilize symmetric cryptography (3DES, AES, etc.) or asymmetric cryptography (RSA, ECC, etc.). The memory 14 may include a unique tag identifier 18 associated with the tag 10 and which can be supplied by a central system during deployment of the tag 10. The transceiver 16 of the tag 10 may correspond to any suitable component capable of establishing bi-directional communication between the tag 10 and user devices such as, for example, mobile device 22, and/or other devices, such as a controller device (not shown).

In some example embodiments, the tag 10 may incorporate a low-cost Near Field Communication (NFC) small component, which is powered or unpowered, which is also capable of communication with an NFC-enabled user device over a short distance (e.g., up to 10 cm), and which can be affixed to a vehicle, station, turnstile, gate, barrier, or other accoutrement associated with systems and networks delivering services, as illustrated, and discussed in further detail herein. It should be appreciated, however, that the targeted usage of the disclosed magnetic detector (i.e., the “detector”) is primarily the case where BLE is used instead of NFC, because with NFC, the phone interrogates the tag, which may contain an active NFC booster waken-up by the phone's field; the idle continuous current of such an active booster is very low (˜10 μA) and therefore it is not very useful to switch the booster off when no phone is in close proximity of the tag. With BLE, on the other hand, the phone will only answer to an advertisement actively emitted by the tag; without a magnetic detector, the tag should continuously advertise and this would use too high a continuous current (˜100 μA); in addition, the phone should be close enough to guarantee a conscious act from its owner (this close distance is also verified by the tag using the RSSI (Received Signal Strength Indication)). There is no reason to exclude NFC communication from the disclosed embodiments. However, BLE is the primary application or focus of the disclosed embodiments.

The terms “user device” or “mobile device” can be utilized interchangeably with one another and denotes a device owned by the user and able to contain and/or process an “application” for interacting with the network delivering services to users. Examples of such a user device include, without limitation, mobile phones, personal data assistants, tablets, and other personal electronic devices. The user device or mobile device 22 may be NFC-enabled and/or Bluetooth enabled (e.g., a BLE (Bluetooth Low Energy) enabled device), as well as capable of data communication with one or more wired or wireless networks, as discussed in greater detail herein. In some example embodiments, a user device or mobile device may be, for example, a computing device such as a wearable computing device (e.g., a smart watch).

It can be appreciated that tags such as tag 10 may be located or placed in a variety of locations and on board vehicles such as, for example, a public transportation vehicle (e.g., a sub, tramway, metro, train, taxis, etc.) or a private commercial transportation vehicle (e.g., an Uber, Lyft, etc.). In such an example scenario, the vehicle and therefore the tag 10 and its magnetic detector 8 may be in close proximity to large alternating magnetic fields, in particular those produced by catenaries. Thus, the filter 9 is configured to filter slow variations of the terrestrial magnetic field in which the vehicle moves and can also filter periodical variations of alternating magnetic fields. The presence of the mobile device 22 can be quickly detected utilizing system 11 without wrongly detecting a strong alternating field.

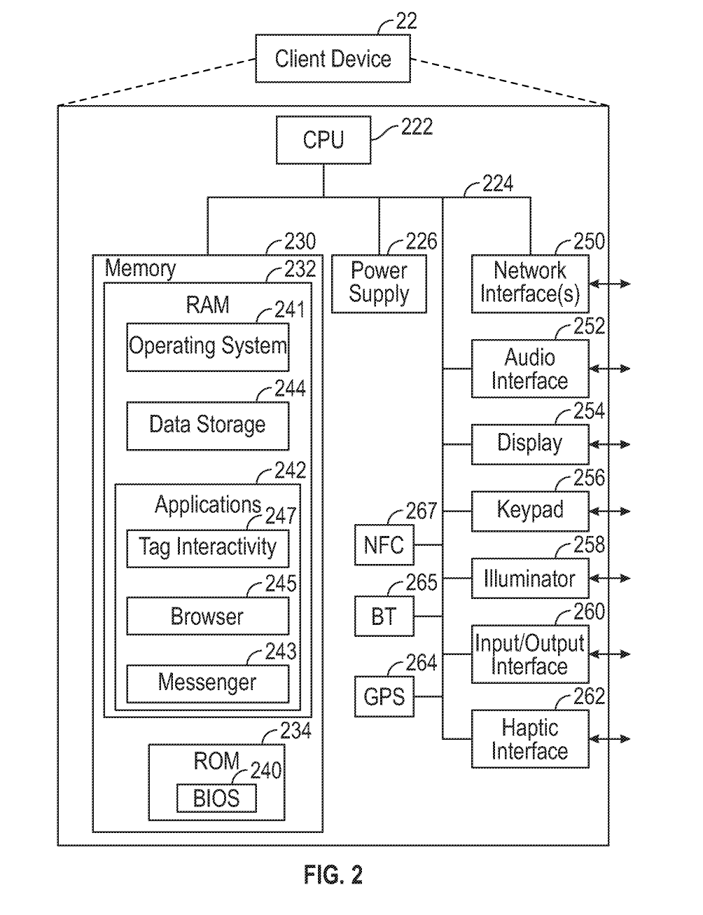

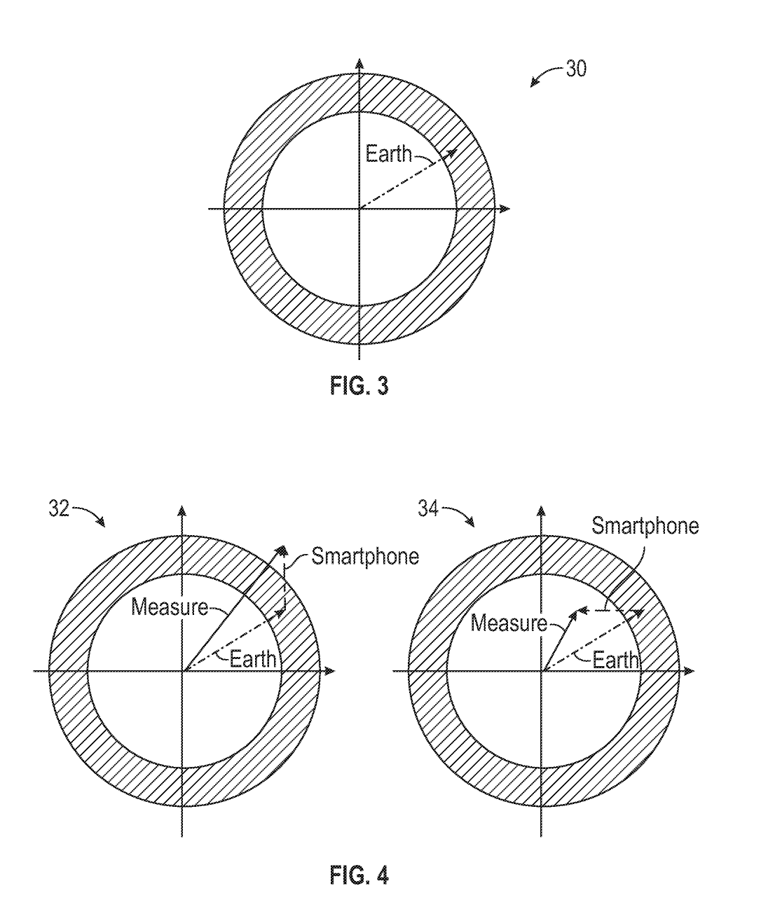

FIG. 2 illustrates a schematic diagram depicting one example embodiment of the mobile device 22 (e.g., a client device) depicted in FIG. 1 and FIG. 3, in accordance with an example embodiment. The client device 22 can function as a computing device capable of sending or receiving signals through a wired or a wireless network.

The client device 22 may be implemented as, for example, a desktop computer or a portable device, such as a cellular telephone, a smartphone, a display pager, a radio frequency (RF) device, an infrared (IR) device, a Personal Digital Assistant (PDA), a handheld computer, a tablet computer, a laptop computer, a wearable computer, or an integrated device combining various features, such as features of the foregoing devices, or the like. In a preferred example embodiment, however, it can be assumed that the client device 22 is a mobile device such as, for example, a smartphone, tablet computing device, a smart watch, or other wearable computing devices.

A client device such as client device 22 may vary in terms of capabilities or features. The claimed subject matter is intended to cover a wide range of potential variations. For example, a cell phone may include a numeric keypad or a display of limited functionality, such as a monochrome liquid crystal display (LCD) for rendering text and other media. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device such as client device 22 may include or may execute a variety of operating systems, such as operating system 241, including in some example embodiments, a personal computer operating system, such as a Windows®, iOS® or Linux®, or a mobile operating system, such as iOS®, Android®, or Windows Mobile®, or the like. A client device such as client device 22 may include or may execute a variety of possible applications, such as a client software application enabling communication with other devices, such as communicating one or more messages, such as via email, short message service (SMS), or multimedia message service (MMS), including via a network, such as an online social network, including, for example, Facebook®, LinkedIn®, Twitter®, Flickr®, Google+® to provide only a few possible examples.

A client device, such as client device 22, may also include or execute an application to communicate content, such as, for example, textual content, multimedia content, or the like. A client device may also include or execute an application to perform a variety of possible tasks, such as browsing, searching, playing various forms of content, including locally stored or streamed video, or games (e.g., fantasy sports leagues, etc.). The foregoing is provided to illustrate that claimed subject matter is intended to include a wide range of possible features or capabilities. Examples of such applications (or modules) can include a messenger 243, a browser 245, and other client application(s) or module(s) such as a tag module 247 that provides instructions for facilitating interactivity and communications between the client device 22 and the tag 10.

The example client device 22 shown in FIG. 2 generally includes a CPU (Central Processing Unit) 222 and/or other processors (not shown) coupled electronically via a system bus 224 to memory 230, power supply 226, and a network interface 250. The memory 230 can be composed of RAM (Random Access Memory) 232 and ROM (Read Only Memory) 234. Other example components that may be included with client device 22 can include, for example, an audio interface 252, a display 254, a keypad 256, an illuminator 258, and an input/output interface 260. In some example embodiments, a haptic interface 262 and a GPS (Global Positioning System) module or unit 264 along with a Bluetooth (BT) module 265 and an NFC (Near Field Communications) module 267 can also be electronically coupled via the system bus 224 to CPU 222, memory 230, power supply 226, and so on.

The BT (Bluetooth) module 265 can permit communication of client device 22 with other devices, including Bluetooth and/or BLE beacons and/or transponders as discussed herein. The near field communication (NFC) module 267 can facilitate NFC communication with other devices including, e.g., an NFC beacon. With respect to the Bluetooth module 265, it may be implemented as a Bluetooth Low Energy (BLE) module and/or a Bluetooth 4.0 module that implements communications using one or more of BLE systems, standard Bluetooth systems, and/or iBeacon systems specifically. As understood herein, BLE may operate in the same spectrum range (the 2.400 GHz-2.4835 GHz band) as classic Bluetooth technology, but may use a different set of channels. Instead of Bluetooth's seventy nine 1-MHz channels, e.g., BLE employs forty 2-MHz channels. BLE may send data within a channel using Gaussian frequency shift modulation with a one megabyte per second data rate and a maximum transmission power of ten milliwatts (10 mW).

RAM 232 can store an operating system 241, provide for data storage 244, and the storage of applications 242 such as, for example, browser 245 and messenger 243 applications. ROM 234 can include a BIOS (Basic Input/Output System) 240, which is a program that the CPU 222 utilizes to initiate the computing system associated with client device 22. BIOS 240 can also manage data flow between operating system 241 and components such as display 254, keypad 256, and so on.

Applications 242 can thus be stored in memory 230 and may be “loaded” (i.e., transferred from, for example, memory 230 or another memory location) for execution by the client device 22. Client device 22 can receive user commands and data through, for example, the input/output interface 260. The client device 22 in accordance with instructions from operating system 241 and/or application(s) 242 may then act upon such inputs. The interface 260, in some embodiments, can serve to display results, whereupon a user may supply additional inputs or terminate a session. The software application(s) 242 can include one or more modules such as modules 243, 245, 247, and so on, which can, for example, implement instructions or operations such as those described herein.

It can be appreciated that there are situations in which a vehicle, and therefore its tag 10 and the magnetic detector 8 may be in close proximity of significant disturbing magnetic fields (e.g., earth field measurement not constant while the bus moves, static field variations due to metallic parts in bridges, alternating magnetic fields, etc). The disclosed embodiments thus utilize several detection methods or approaches simultaneously to detect the presence of a mobile computing device such as the mobile computing device or client device 22 shown in FIGS. 1-2 without inaccurately detecting all other field variations. Several algorithms or approaches have been developed, each one allowing the detection of some specific users' movements when approaching their smartphone in close proximity of a tag such as, for example, tag 10 shown in FIG. 1.

The first algorithm or approach uses the magnetic field strength, computed as SQR(Hx²+Hy²+Hz²), with Hx, Hy and Hz representing the 3 components measured by a 3-dimensional magnetic field sensor. This field strength mostly represents the earth's magnetic field strength, which is constant when the vehicle moves and changes direction. Because of significant disturbing magnetic fields (e.g., field variations due to metallic parts in bridges) and also errors in field measurement (e.g., magnetic sensor offset due to magnetic shocks), an optimum threshold must be used to not detect disturbing magnetic fields while detecting smartphones as well as possible, for users' convenience.

The second algorithm or approach uses the derivative of the field vector, i.e., the vector obtained by the difference between two consecutive field vectors measurements. In this case, the errors in field measurement, especially the magnetic sensor offset, are compensated, but the vehicle movements are detected if they are not much slower than the smartphone movements. An optimum threshold must therefore be used. A variant of this second method is to use only the projection of the derivative of the field vector on the vertical axis, because the bus movement is mostly horizontal. With this variant a much lower threshold may be used, which improves the detection of mobile computing devices such as smartphones that provide some vertical magnetic field.

The third algorithm or approach uses the second derivative of the field vector, i.e., the vector obtained by the difference between two consecutive computations of the derivative of the field vector. In this case, the errors in field measurement and the vehicle movements are mostly compensated, which make this third method very efficient if the users' movements are fast.

Each algorithm threshold needs to be carefully chosen so that the tag easily detects the presence of a smartphone without wrongly detect all other field variations to minimize the battery consumption. The wrong detections of each algorithm will be continuously monitored and the corresponding thresholds adapted so that, when the bus moves in a disturbed area, the tag power consumption stays to a minimum by reducing the algorithms sensitivities. The association of these 3 methods and the auto-adaptation of their thresholds can provide for both versatile smartphone detection and a long battery life.

FIG. 3 illustrates a schematic diagram 30 of magnetic field strength demonstrating that when only the Earth's magnetic field is present and a vehicle moves, the measured field strength is constant, in accordance with an example embodiment.

FIG. 4 illustrates schematic diagrams 32 and 34 of magnetic field strength in a respective first case and a respective second case, in accordance with an example embodiment. In the first case shown at the left hand side of FIG. 4 in the schematic diagram 32, the magnetic field associated with the smartphone adds the Earth's field and the measured total field strength increases and exceeds the maximum field strength threshold with respect to the external circle shown in the schematic diagram 32. In the second case, which is illustrated at the right hand side of FIG. 4 via the schematic diagram 34, the magnetic field associated with the smartphone also adds to the Earth's field, but the measured total field strength decreases and exceeds the minimum field strength threshold with respect to the internal circle shown in the schematic diagram 34.

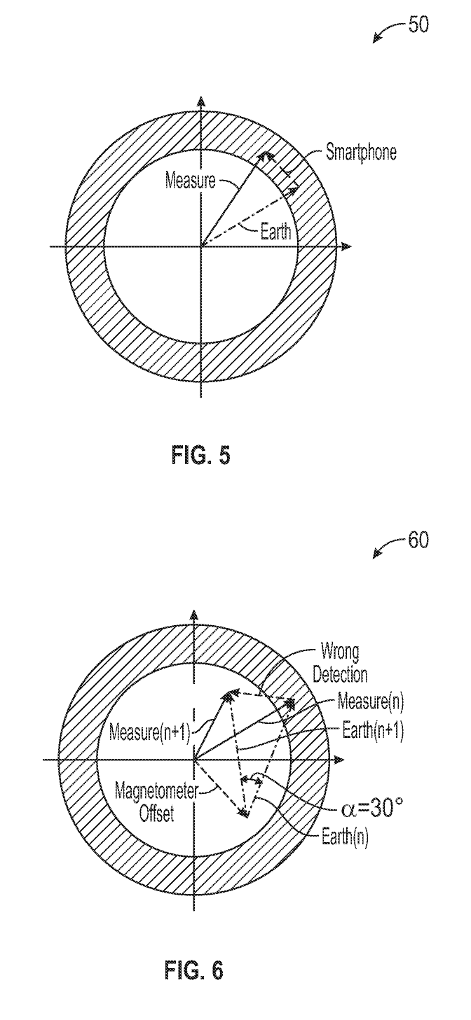

FIG. 5 illustrates a schematic diagram 50 of magnetic field strength in a third case, in accordance with an example embodiment. In the third case shown in the schematic diagram 50, the magnetic field associated with the smartphone adds to the Earth's field, but the measured total field strength does not change and therefore does not cross any of the two thresholds.

FIG. 6 illustrates a schematic diagram 60 of magnetic field strength in a fourth case, in accordance with an example embodiment. In the fourth case shown in the schematic diagram 60 of FIG. 6, no smartphone is present. In this case, the magnetic sensor offset adds to the Earth's field and the vehicle (I.e., in which a smartphone may be located) turns. The measured total field strength also changes and exceeds the minimum field strength threshold.

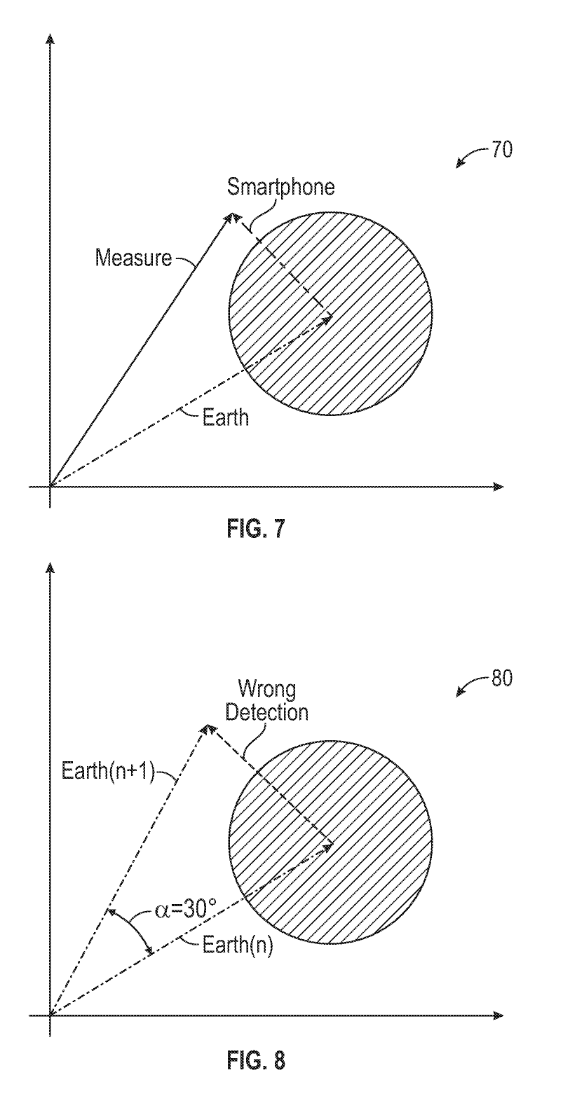

FIG. 7 illustrates a graph 70 of the derivative of the field vector in a first case, in accordance with an example embodiment. In the case shown in FIG. 7, the smartphone field adds to the Earth's field and the measured total field changes only in its direction (in this particular figure) and its derivative exceeds the threshold shown as a circle in FIG. 7. It can be appreciated that this solves case 3 of the magnetic field strength approach or method discussed in further detail herein where the magnetic field strength does not change.

FIG. 8 illustrates a graph 80 of the derivative of the field vector in a second case, in accordance with an example embodiment. In the second case of graph 80 shown in FIG. 8, no smartphone is present, and the vehicle turns. In addition, the measured total field changes and its derivative exceed the threshold.

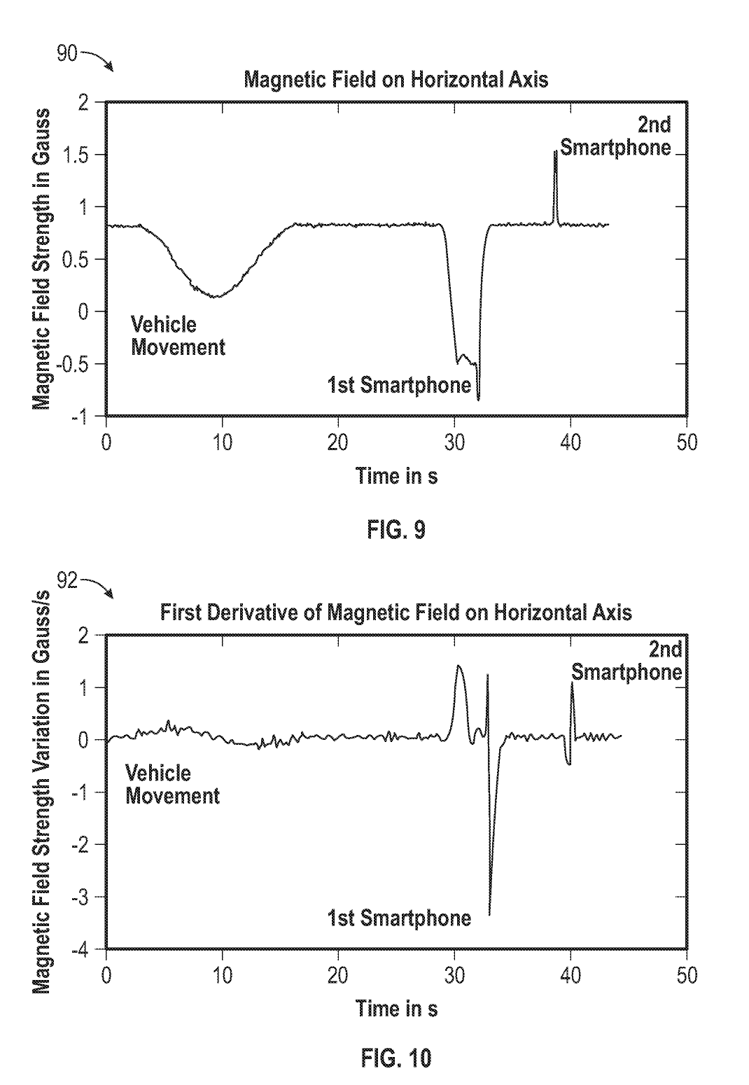

FIG. 9 illustrates a graph 90 depicting the temporal evolution of the field vector, in accordance with an example embodiment. The graph 90 generally illustrates the magnetic field on a horizontal axis (i.e., parallel to the Earth's surface), with respect to vehicle movement and first and second smartphones.

FIG. 10 illustrates a graph 92 depicting the temporal evolution of the first derivative of the magnetic field vector on the horizontal axis with respect to vehicle movement and first and second smartphones, in accordance with an example embodiment.

FIG. 11 illustrates a graph 96 depicting the temporal evolution of the second derivative of the magnetic field vector on the horizontal axis with respect to vehicle movement and first and second smartphones, in accordance with an example embodiment. The data depicted in graph 96 indicates that with the second derivative of the magnetic field, the vehicle movement is no longer visible while the first and second smartphones are detected.

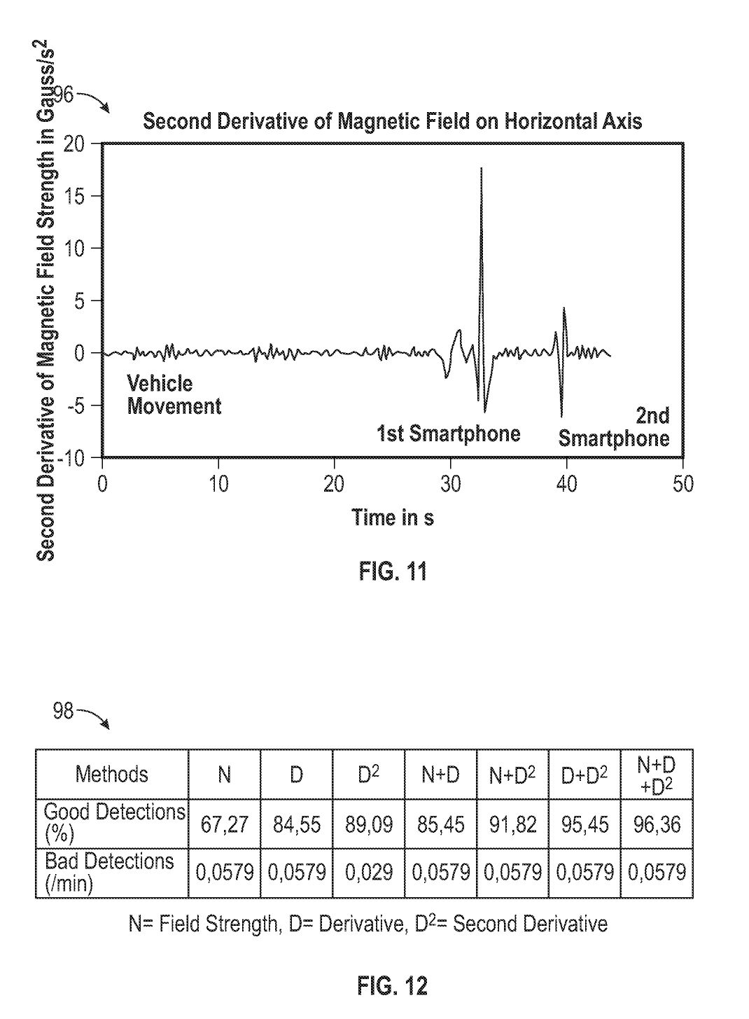

FIG. 12 illustrates a table 98 depicting the performance of various detection methods based on field strength and/or first and/or second derivatives, in accordance with an example embodiment. The table 98 includes example data, which illustrates both the pros and cons of each detection method. The association of the three methods/approaches, together with continuous offsets compensation, provides a robust detection for many types of mobile computing devices.

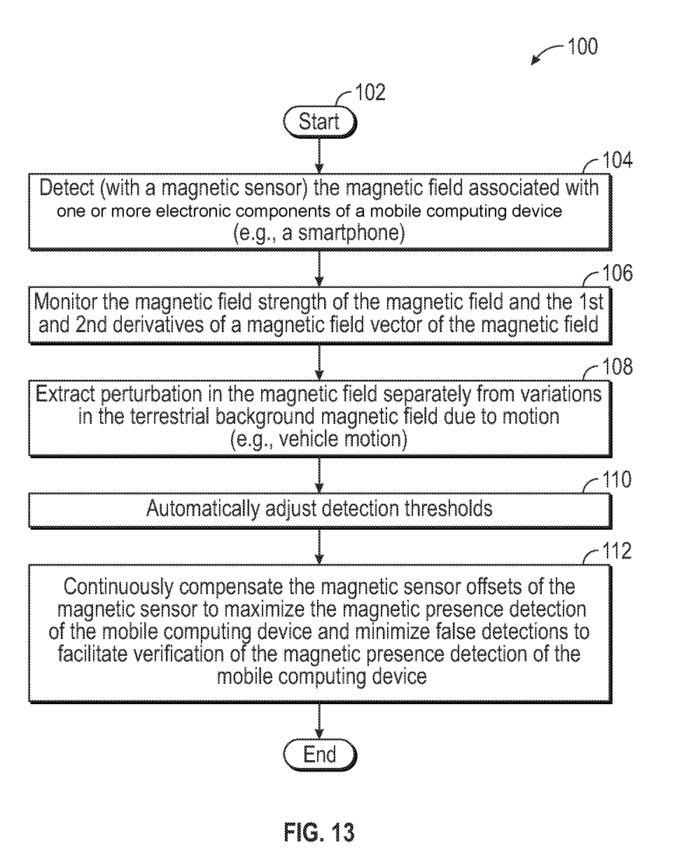

FIG. 13 illustrates a flow chart of operations depicting logical operational steps of a method 100 for improving the magnetic presence detection of a user device or client device, such as a smartphone, tablet computing device, and so on, in accordance with an example embodiment. The method 100 shown in FIG. 13 includes various, steps, operations, or instructions that are described with respect to various blocks. As shown at block 102, the process begins. Thereafter, as indicated at block 104, a step or operation can be implemented in which a magnetic sensor is used to detect the magnetic field associated with one or more components (e.g., an electromagnetic component such as a speaker) of a mobile computing device (e.g., a smartphone, tablet computing device, wearable computing device, and so on).

Next, as depicted at block 106, a step or operation can be implemented to monitor the magnetic field strength and/or the first and/or second derivative of the magnetic field vector (i.e., in the position where the sensor is located, giving the 3 coordinates of the vector, hence allowing to compute its strength and its first and second derivatives). Note that a magnetic field vector can be considered as one of the three measured components of the field vector (or as any other projection of the field vector on a plane or an axis). Regarding the term “field vector” as utilized herein, it is important to note that the first/second derivative may apply to the field vector itself (in 3D) or to any projection of the field vector (in 2D or in 1D). In particular, the first derivative can apply to the projection on the one-dimension vertical axis (i.e., on the vertical component of the field vector). In addition, as utilized herein, the term “a vector” can represent a projection of the (measured) field vector. In any event, the complete measured magnetic field strength is measured and monitored, not just the magnetic field of the mobile computing device.

Following processing of the operation indicated at block 106, a step or operation can be processed, as shown at block 108, to extract a perturbation in the magnetic field separately from variations in the terrestrial background magnetic field due to motion (e.g., motion of a vehicle). Thereafter, as depicted at block 110, a step or operation can be implemented for automatically adjusting detection thresholds. Note that the threshold adjustment can be performed later (e.g., increase after having done too many false detections, decrease after a certain time without any false detection). As shown next at block 112, steps or operations can be processed for continuously compensating magnetic sensor offsets of the magnetic sensor to maximize the magnetic presence detection of the mobile computing device and minimize false detections thereof (note that both the offset compensation and threshold adjustment have this goal).

The method 100 shown in FIG. 13 thus generally describes a methodology for the versatile magnetic presence detection of a mobile computing device by a tag. That is, a vehicle such as a bus, and therefore the tag and its magnetic detector, may in some situations be in close proximity to significant disturbing magnetic fields (e.g., the earth's field measurement is not constant while the vehicle moves, static field variations may be present due to metallic parts in bridges and other structures, alternating magnetic fields may be present due to catenaries, etc.). The approach of method 100 thus involves using simultaneously several detection methods or approaches to detect the presence of a mobile computing device without wrongly detecting all other field variations.

Several approaches can be implemented to achieve these goals, wherein each allows for the detection of some specific users' movements when approaching their mobile computing device in close proximity to a tag.

The first approach uses the magnetic field strength, computed as SQR(Hx²+Hy²+Hz²), with Hx, Hy and Hz representing the 3 components measured by a 3-dimensional magnetic field sensor. This approach can be implemented in the context of, for example, the step or operation shown at block 106 in FIG. 13 (i.e., monitoring the magnetic field strength of the magnetic field). This field strength mostly represents the earth's magnetic field strength, which is constant when the vehicle moves and changes direction. Because of significant disturbing magnetic fields (e.g., field variations due to metallic parts in bridges) and also errors in field measurement (e.g., magnetic sensor offset due to magnetic shocks), an optimum threshold must be used to not detect disturbing magnetic fields while detecting smartphones as well as possible, for users' convenience.

The second approach uses the derivative of the field vector, i.e., the vector obtained by the difference between two consecutive field vectors measurements. This approach can also be implemented in the context of the operation shown at block 106. In this case, the errors in field measurement, especially the magnetic sensor offset, are compensated, but the vehicle movements (especially rotations) are detected if they are not much slower than the smartphone movements. An optimum threshold must therefore be used. A variant of this second method is to use only the projection of the derivative of the field vector on the vertical axis, because the bus movement is mostly horizontal. With this variant, a much lower threshold may be used, which is helpful in improving the detection of mobile computing devices that provide some vertical magnetic field.

The third approach uses the second derivative of the field vector, i.e., the vector obtained by the difference between two consecutive computations of the derivative of the field vector. This approach can also be implemented in the context of the operation or step shown at block 106 in FIG. 13. In this case, the errors in field measurement and the vehicle movements are mostly compensated, which make this third method very efficient if the users' movements are fast.

Each threshold should be carefully considered and selected so that the tag easily detects the presence of a mobile computing device without wrongly detecting all other field variations, in order to minimize the battery consumption. The wrong detections of each approach or algorithm will be continuously monitored (e.g., see the step or operation of block 112 in FIG. 13) and the corresponding thresholds adapted so that, when the aforementioned example vehicle moves in a disturbed area, the tag power consumption remains at a minimum by reducing the algorithms' sensitivities. The association of these three approaches or algorithms and the auto-adaptation of their thresholds provides for both versatile mobile computing device detection and a longer battery life. It can be appreciated that this approach improves the underlying technology itself. That is, the disclosed embodiments can result in improvements in battery life, which results in an improvement to the function of the underlying technology, such as mobile computing devices, wireless communications, and so on.

The disclosed embodiments can thus use the magnetic field associated with one or more components (e.g., an electromagnetic component such as a speaker) of a mobile computing device for proximity detection for a mobile ticketing application or “app.” Note that as utilized herein the term mobile ticketing refers generally to a process facilitated by electronic devices and electronic communications, whereby customers can order, pay for, obtain, and/or validate tickets using, for example, mobile computing devices.

A Bluetooth Low Energy (BLE) interface that communicates with the mobile computing device is only turned on or activated when the mobile computing device is placed near the magnetic sensor (e.g., magnetic proximity detector 8) to avoid draining the battery of the device. By monitoring the magnetic field strength and/or the first and/or second derivative of the magnetic field vector (i.e., in the position where the sensor is located, giving the 3 coordinates of the vector, hence allowing to compute its strength and its first and second derivatives), the perturbation in the magnetic field from the mobile computing device can be extracted separately from the variations in the Earth's background magnetic field due to the motion of, for example, a vehicle such as a bus. The detection thresholds are automatically adjusted and the magnetic sensor offsets are continuously compensated to maximize phone detection and minimize the false detections. Benefits of the disclosed embodiments include extending the life of the ticketing device, which will reduce costs due to longer life and the minimization of failures.

As can be appreciated by one skilled in the art, embodiments can be implemented in the context of a method, data processing system, or computer program product. Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object-oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the users computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi, Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example, a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein. Such instructions can, for example, include instructions (i.e., steps or operations) such as those depicted in FIGS. 1-13 herein.

Note that a processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include a general-purpose processor, a digital signal processor (DSP), an integrated circuit, a server, other programmable logic device, or any combination thereof. A processor may be a conventional processor, microprocessor, controller, microcontroller, or a state machine. A processor can also refer to a chip or part of a chip (e.g., semiconductor chip). The term “processor” may refer to one, two or more processors of the same or different types. It is noted that a computer, computing device and user device, and the like, may refer to devices that include a processor, or may be equivalent to the processor itself.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

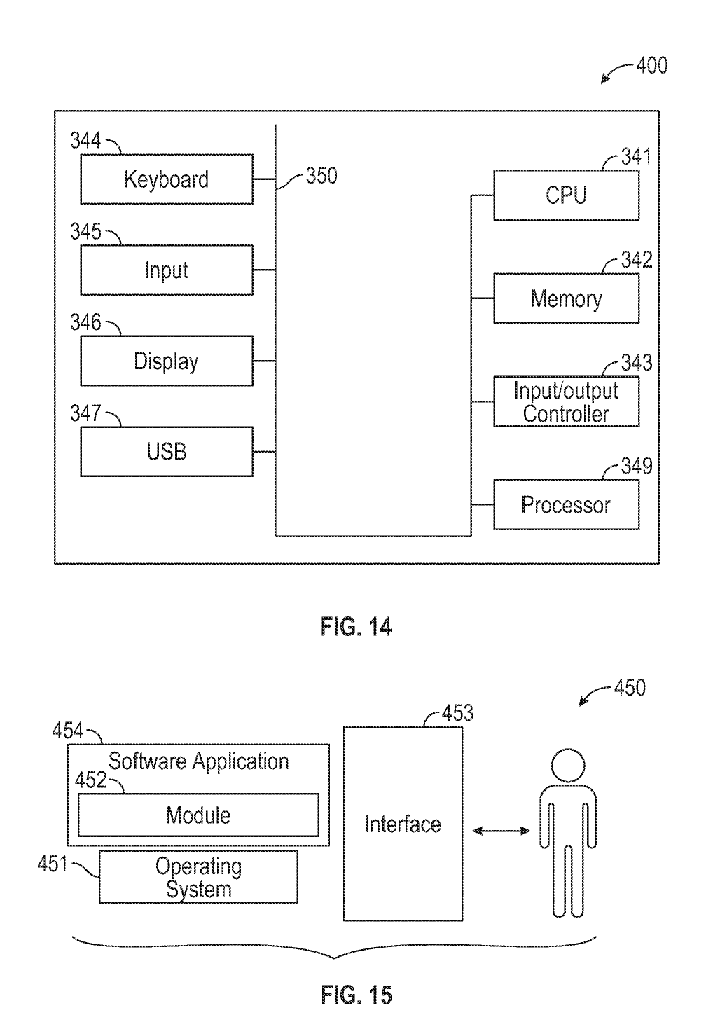

FIGS. 14-15 are shown only as exemplary diagrams of data-processing environments in which example embodiments may be implemented. It should be appreciated that FIGS. 14-15 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 14, some embodiments may be implemented in the context of a data-processing system/apparatus 400 that can include, for example, one or more processors such as a processor 341 (e.g., a CPU (Central Processing Unit) and/or other microprocessors), a memory 342, an input/output controller 343, a processor 349 (e.g., microprocessor, controller, microcontroller, state machine, etc.), a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.) and/or other peripheral connections and components.

As illustrated, the various components of data-processing system/apparatus 400 can communicate electronically through a system bus 350 or similar architecture. The system bus 350 may be, for example, a subsystem that transfers data between, for example, computer components within data-processing system/apparatus 400 or to and from other data-processing devices, components, computers, etc. The data-processing system/apparatus 400 may be implemented in some embodiments as, for example, a server in a client-server based network (e.g., the Internet) or in the context of a client and a server (i.e., where aspects are practiced on the client and the server).

In some example embodiments, data-processing system/apparatus 400 may be, for example, a standalone desktop computer, a laptop computer, a smartphone, a pad computing device, and so on, wherein each such device is operably connected to and/or in communication with a client-server based network or other types of networks (e.g., cellular networks, Wi-Fi, etc.).

FIG. 15 illustrates a computer software system/apparatus 450 for directing the operation of the data-processing system/apparatus 400 depicted in FIG. 14. Software application 454 includes a module 452 (note the module 452 may be stored in, for example, the memory 342 shown in FIG. 14). The computer software system/apparatus 450 also generally includes a kernel or operating system 451 and a shell or interface 453. One or more application programs, such as software application 454, may be “loaded” (i.e., transferred from, for example, mass storage or another memory location into the memory 342) for execution by the data-processing system/apparatus 400. The data-processing system/apparatus 400 can receive user commands and data through the interface 453; these inputs may then be acted upon by the data-processing system/apparatus 400 in accordance with instructions from operating system 451 and/or software application 454. The interface 453 in some embodiments can serve to display results, whereupon a user (e.g., shown in FIG. 15 to right of the interface 453) may supply additional inputs or terminate a session. The software application 454 can include the module(s) 452, which can, for example, implement the various instructions or operations such as those discussed herein with respect to FIGS. 1-13 and elsewhere herein. Module 452 may also be composed of a group of modules or sub-modules that implement particular modules, such as, for example, the various modules (and components/features, etc.) discussed and illustrated herein with respect to FIGS. 1-13.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. In other embodiments, a module may refer to a hardware component or a combination of hardware and software.

FIGS. 14-15 are thus intended as examples and not as architectural limitations of the disclosed embodiments. Additionally, such example embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, such as but not limited to Macintosh, UNIX, LINUX, and so on.

Based on the foregoing, it can be appreciated that a number of example embodiments are disclosed herein. For example, in one embodiment, a method can be implemented for the magnetic presence detection of a mobile computing device. Such a method can include steps or operations such as, for example, detecting with a magnetic sensor a magnetic field associated with one or more components of a mobile computing device; monitoring a magnetic field strength of the magnetic field and/or a first and/or a second derivative of a magnetic field vector of the magnetic field of the component(s) of the mobile computing device; and extracting a perturbation in the magnetic field separately from variations in a terrestrial background magnetic field due to motion in order to maximize the magnetic presence detection of the mobile computing device and minimize false detections thereof.

In some example embodiments, steps or operations can be provided for automatically adjusting detection thresholds; and/or continuously compensating magnetic sensor offsets of the magnetic sensor to maximize the magnetic presence detection of the mobile computing device and minimize the false detections thereof. In addition, in some example embodiments, the aforementioned component (or components) of the mobile computing device can be a component such as a speaker associated with the mobile computing device.

In yet another example embodiment, a step or operation can be provided for automatically activating a BLE (Bluetooth Low Energy) interface to communicate with the mobile computing device only when the mobile computing is placed near the magnetic sensor and the magnetic presence detection of the mobile computing device is verified to avoid draining a battery associated with the mobile computing device.

In some example embodiments, mobile computing device may be a smartphone, while in other example embodiments, the mobile computing device may be a tablet computing device. In yet other example embodiments, the mobile computing device may be a wearable computing device.

In still another example embodiment, a system for the magnetic presence detection of a mobile computing device can be implemented. Such a system can include, for example, a magnetic sensor that detects a magnetic field associated with one or more components of a mobile computing device. In such an embodiment, a magnetic field strength of the magnetic field and/or a first and/or a second derivative of a magnetic field vector of the magnetic field of the component(s) of the mobile computing device can be monitored. In addition, a perturbation in the magnetic field can be extracted separately from variations in a terrestrial background magnetic field due to motion in order to maximize the magnetic presence detection of the mobile computing device and minimize false detections thereof.

In yet another example embodiment, a system for a magnetic presence detection of a mobile computing device can be implemented. Such a system can include, for example, one or more processors and a non-transitory computer-usable medium embodying computer program code. The computer-usable medium can communicate with the processor(s). The computer program code can include instructions executable by the processor(s) and configured for: detecting with a magnetic sensor a magnetic field associated with one or more components of a mobile computing device; monitoring a magnetic field strength of the magnetic field and/or a first and/or a second derivative of a magnetic field vector of the magnetic field of the component(s) of the mobile computing device; extracting a perturbation in the magnetic field separately from variations in a terrestrial background magnetic field due to motion; and automatically adjusting detection thresholds and/or continuously compensating magnetic sensor offsets of the magnetic sensor in order to maximize the magnetic presence detection of the mobile computing device and minimize false detections thereof.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for a magnetic presence detection of a mobile computing device, comprising:
detecting with a magnetic sensor a magnetic field associated with at least one component of a mobile computing device;
monitoring a magnetic field strength of said magnetic field and/or a first and/or a second derivative of a magnetic field vector of said magnetic field of said at least one component of said mobile computing device; and
extracting a perturbation in said magnetic field separately from variations in a terrestrial background magnetic field due to motion in order to maximize said magnetic presence detection of said mobile computing device and minimizes false detections thereof.

2. The method of claim 1 further comprising:
automatically adjusting detection thresholds; and/or
continuously compensating magnetic sensor offsets of said magnetic sensor to maximize said magnetic presence detection of said mobile computing device and minimize said false detections thereof.

3. The method of claim 1 wherein said at least one component of said mobile computing device comprises a speaker associated with said mobile computing device.

4. The method of claim 1 further comprising automatically activating a BLE (Bluetooth Low Energy) interface to communicate with said mobile computing device only when said mobile computing is placed near said magnetic sensor and said magnetic presence detection of said mobile computing device is verified to avoid draining a battery associated with said mobile computing device.

5. The method of claim 1 wherein said mobile computing device comprises a smartphone.

6. The method of claim 1 wherein said mobile computing device comprises a tablet computing device.

7. The method of claim 1 wherein said mobile computing device comprises a wearable computing device.

8. A system for a magnetic presence detection of a mobile computing device, said system comprising:
a magnetic sensor that detects a magnetic field associated with at least one component of a mobile computing device;
wherein a magnetic field strength of said magnetic field and/or a first and/or a second derivative of a magnetic field vector of said magnetic field of said at least one component of said mobile computing device are monitored; and
wherein a perturbation in said magnetic field is extracted separately from variations in a terrestrial background magnetic field due to motion in order to maximize said magnetic presence detection of said mobile computing device and minimizes false detections thereof.

9. The system of claim 8 wherein detection thresholds are automatically adjusted and/or magnetic sensor offsets of said magnetic sensor are continuously compensated to maximize said magnetic presence detection of said mobile computing device and minimize said false detections thereof.

10. The system of claim 8 wherein said at least one component of said mobile computing device comprises a speaker associated with said mobile computing device.

11. The system of claim 8 wherein a BLE (Bluetooth Low Energy) interface is automatically activated to communicate with said mobile computing device only when said mobile computing is placed near said magnetic sensor and said magnetic presence detection of said mobile computing device is verified to avoid draining a battery associated with said mobile computing device.

12. The system of claim 8 wherein said mobile computing device comprises a smartphone.

13. The system of claim 8 wherein said mobile computing device comprises a tablet computing device.

14. The system of claim 8 wherein said mobile computing device comprises a wearable computing device.

15. A system for a magnetic presence detection of a mobile computing device, said system comprising:
at least one processor; and
a non-transitory computer-usable medium embodying computer program code, said computer-usable medium capable of communicating with said at least one processor, said computer program code comprising instructions executable by said at least one processor and configured for:
detecting with a magnetic sensor a magnetic field associated with at least one component of a mobile computing device;
monitoring a magnetic field strength of said magnetic field and/or a first and/or a second derivative of a magnetic field vector of said magnetic field of said at least one component of said mobile computing device;
extracting a perturbation in said magnetic field separately from variations in a terrestrial background magnetic field due to motion; and
automatically adjusting detection thresholds and/or continuously compensating magnetic sensor offsets of said magnetic sensor in order to maximize said magnetic presence detection of said mobile computing device and minimize false detections thereof.

16. The system of claim 15 wherein said at least one component of said mobile computing device comprises a speaker associated with said mobile computing device.

17. The system of claim 15 wherein said instructions are further configured for automatically activating a BLE (Bluetooth Low Energy) interface to communicate with said mobile computing device only when said mobile computing is placed near said magnetic sensor and said magnetic presence detection of said mobile computing device is verified to avoid draining a battery associated with said mobile computing device.

18. The system of claim 15 wherein said mobile computing device comprises a smartphone.

19. The system of claim 15 wherein said mobile computing device comprises a tablet computing device.

20. The system of claim 15 wherein said mobile computing device comprises a wearable computing device.
